(19) United States
(12) Patent Application Publication
(10) Pub. No.: US 2024/0208040 A1
(43) Pub. Date: Jun. 27, 2024

(54) TOOL STORAGE ASSEMBLY

(71) Applicant: Dustan Coons, Ankeny, IA (US)

(72) Inventor: Dustan Coons, Ankeny, IA (US)

(21) Appl. No.: 18/392,177

(22) Filed: Dec. 21, 2023

Related U.S. Application Data
(60) Provisional application No. 63/476,570, filed on Dec. 21, 2022.

(51) Int. Cl. B25H 3/02; B65D 21/02; B65D 25/20; B65D 43/16

(52) U.S. Cl. CPC B25H 3/023; B65D 21/0217; B65D 25/20; B65D 43/16; B62B 1/10; B65D 2543/00194

(57) ABSTRACT

The disclosure provided herein is directed to a tool storage assembly that may include a dolly system that connects or receives a plurality of storage containers that form a stack assembly. The storage containers may be interlocked with one another with an interlock assembly that may include a tether to prevent the lid of any one storage container from opening beyond a predefined distance. The tool storage assembly has a stabilizer assembly that uses one or more anchors to stabilize the stack assembly when a lower storage container is opened without disassembling or removing the containers atop the lower storage container. An exterior storage assembly may also provide tool access about an exterior of the tool storage assembly.

### CROSS REFERENCE TO RELATED APPLICATION

This application claims the benefit U.S. Provisional Application Ser. No. 63/476,570 filed Dec. 21, 2022, the contents of this application is hereby incorporated by reference in its entirety.

### BACKGROUND OF THE INVENTION

This disclosure generally relates to a tool storage assembly. More specifically, the disclosure relates to a tool storage assembly having a stack of two or more storage containers that are accessible without the disassembly of the stack to obtain access to a storage container positioned below or under another of the storage container or storage containers.

Tool storage assemblies are known in the art and span a range of configurations, including a single toolbox transported by a handle and a large multi-drawer tool chest that are fitted with wheels to permit movement. While useful, individual toolboxes are too small to hold many tools, parts, and the like used on large, complex job sites. Tool chests also have drawbacks due to their large size which limits the ability to easily transport them between one job site to another as disassembly is not possible.

One advancement that has taken place is the use of tool storage assemblies that combines aspects of a toolbox, a tool chest, and a dolly into a mobile, stacked tool storage assembly 210 of a plurality of storage containers that are integrated into a dolly assembly 212 that is formed by a bottommost of the tool storage containers 244 forming a stack assembly 214 functioning as a base with a handle receiver 224 from which the arm or arms 228 of the handle 222 is received and extend from. Some examples of the prior art that are depicted in FIGS. 1 and 2.

Another advancement with such tool storage assemblies is the mating interlock of the storage containers to one another, such as a bottom of a storage container positioned above a lower storage container is retained in place by a lip or flange on a lid of a lower storage container. Alternatively, the bottom of the storage container above may have feet that are received within recesses of the lid below. Such a configuration allows for quick assembly and disassembly of the stack while providing some rigidity to the stack when the tool storage assembly is moved from one location to another. A further advancement relates to the handle 222 having arms 228 being telescopically collapsible into the body 236 handle receiver 224 to allow a storage container in the middle of the stack to be opened without interference with arms of the handle.

Despite these advances and others, problems still remain. In particular, accessing any of the storage containers except for the storage container on top requires removing all storage containers on top of the storage container being accessed as shown in FIGS. 1 and 2. Additionally, the height of the handle receiver 224 is such that the lid 252 of the lower storage container 244 on the bottom of the stack assembly 214 cannot be opened fully, which is further inhibited if a user attempts to open that lower storage container 214 with another storage container still stacked above as seen in FIG. 2. Accordingly, the stack assembly 214 must be disassembled to access the lower storage compartment 250 of the lower or lowest storage container 244 in the stack assembly 214.

Another disadvantage related to accessing storage container when the stack assembly 214 is fully assembled relates to the weight imbalance caused by lifting the lid of one storage container while other storage containers remain atop. When the storage containers of the stack assembly 214 are weighted down with tools, parts, and the like, the weight of the stack is substantial. Should one attempt access to a storage container without removal of the storage containers above, there is a significant risk that the storage containers above will topple off of the stack causing harm to individuals, the storage containers, and the contents therein. Additionally, there is the substantial risk that the displacement of weight backwards will cause the stack assembly 214 to slide out or slip out from under itself and into the one attempting to gain access without disassembly. This is particularly dangerous as the tool storage assembly 210 is commonly accessed from the front of the tool storage assembly 210.

With further reference to FIGS. 1 and 2, some prior art tool storage assembly 210 have a grab handle 306 that is positioned on a front 292 of the lowest storage container 244. The grab handle 306 is configured to extend upwards and away from a bottom edge 286 of lowest storage container 244 such that a grip portion 308 of the grab handle 306 is spaced away from a ground surface 288 to allow a hand to pass below to grip the grab handle 306 in such a way that lifting the tool storage assembly 210 is facilitated. While disclosure will be made of a stabilizer assembly herein, the grab handle 306 is not to be considered within the scope of the stabilizer assembly given its structural unsuitability for use, including the grab handle 306 being shallowing positioned away from the front 292 of the lowest storage container 244. Furthermore, the shape and configuration of the grab handle 306 is unsuitable for use due to the fragility of the shape used and the separation between the grip portion 286 and the ground surface 288, which in some instances is further exacerbated by the extrusion of the grab handle 306 away from the lower edge 286 of the lowest storage container 244.

Thus it is a primary aspect of this disclosure to provide a tool storage assembly that improves upon the art.

Another aspect of this disclosure is to provide a tool storage assembly that improves access.

Yet another aspect of this disclosure is to provide a tool storage assembly that limits stack disassembly.

Another aspect of this disclosure is to provide a tool storage assembly that can be retrofitted into a stack that is pre-existing.

Yet another aspect of this disclosure is to provide a tool storage assembly that provides a counterweight.

Another aspect of this disclosure is to provide a tool storage assembly that improves rigidity.

Yet another aspect of this disclosure is to provide a tool storage assembly that reduces tipping, toppling, and/or slipping out.

Another aspect of this disclosure is to provide a tool storage assembly that is modular.

Yet another aspect of this disclosure is to provide a tool storage assembly that is transportable.

Another aspect of this disclosure is to provide a tool storage assembly that increases safety.

Yet another aspect of this disclosure is to provide a tool storage assembly that is user-friendly.

These and other aspects, features, and advantages of the invention will become apparent from the specification and claims.

### SUMMARY OF THE INVENTION

The disclosure provides various aspects of a tool storage assembly.

In aspects of the disclosure, broadly described herein, relate to a tool storage assembly including: a dolly assembly connected to a stack assembly; the stack assembly having an upper storage container stacked atop a lower storage container; and a stabilizer assembly having at least one anchor connected to a lower edge, wherein the at least one anchor extends perpendicularly away from the stack assembly; wherein the lower storage container is accessible without removal of the upper storage container from the stack assembly, and the at least one anchor is configured to be stepped on to provide a counterweight to an offset created by a displacement of the upper storage container when the lower storage container is accessed.

In aspects of the disclosure, broadly described herein, relate to a tool storage assembly wherein the at least one anchor is hingedly connected to the lower storage container.

In aspects of the disclosure, broadly described herein, relate to a tool storage assembly further including the counterweight received on the at least one anchor, wherein the counterweight offsets the displacement of the upper storage container when the lower storage container is open with the upper storage container positioned atop of the lower storage container.

In aspects of the disclosure, broadly described herein, relate to a tool storage assembly further including an interlock assembly is configured to secure the stack assembly together.

In aspects of the disclosure, broadly described herein, relate to a tool storage assembly further including an exterior storage system configured to store materials to an exterior of the stack assembly.

In aspects of the disclosure, broadly described herein, relate to a tool storage assembly further including the lower storage container having a lower compartment and a lower lid, wherein the lower lid is configured to open from a first side of the stack assembly towards a second side of the stack assembly; and the dolly assembly having a handle connected to a rear of the stack assembly.

In aspects of the disclosure, broadly described herein, relate to a tool storage assembly wherein the at least one anchor includes a side anchor connected to the lower edge on the first side of the stack assembly.

In aspects of the disclosure, broadly described herein, relate to a tool storage assembly wherein the at least one anchor includes a front anchor connected to the lower edge of the first side of the stack assembly.

In aspects of the disclosure, broadly described herein, relate to a tool storage assembly further including the lower storage container having a lower compartment and a lower lid, wherein the lower lid is configured to open from a front of the stack assembly towards a rear of the stack assembly; and the dolly assembly having a handle connected to the rear of the stack assembly.

In aspects of the disclosure, broadly described herein, relate to a tool storage assembly wherein the at least one anchor includes a front anchor connected to the lower edge of a front side of the stack assembly.

In aspects of the disclosure, broadly described herein, relate to a tool storage assembly further including the dolly assembly having a handle that is telescopically received within a handle receiver, wherein when telescopically collapsed the handle is positioned at least flush with a lower lid of the lower storage container such that the handle does not obstruct the lower lid from opening more than a right angle in relation to a lower compartment of the lower storage container.

In aspects of the disclosure, broadly described herein, relate to a tool storage assembly wherein the handle receiver is monolithically constructed with at least the lower storage container.

In aspects of the disclosure, broadly described herein, relate to a tool storage assembly further including a tether connected to and between a lower compartment and a lower lid, wherein the tether is configured to limit a distance the lower lid can be opened in relation to the lower compartment.

In aspects of the disclosure, broadly described herein, relate to a tool storage assembly further including a lid fastener positioned below and through a lower lid of the lower storage container and through and above an intermediate compartment of an intermediate storage container, wherein the lid fastener is configured to provide a static and fixed interconnection between the lower storage container and the intermediate storage container of the stack assembly.

In aspects of the disclosure, broadly described herein, relate to a tool storage assembly further including the stack assembly having an intermediate storage container; the intermediate storage container having a front anchor extending away from a front of the stack assembly.

In aspects of the disclosure, broadly described herein, relate to a tool storage assembly wherein the at least one anchor is slidably connected to the lower storage container, wherein the at least one anchor is selectively receivable within an anchor recess formed in the lower storage container.

In aspects of the disclosure, broadly described herein, relate to a tool storage assembly including: a dolly assembly connected to a stack assembly; the stack assembly having an upper storage container stacked atop a lower storage container; the upper storage container selectively stacked atop the lower storage container by an interlock assembly; and a stabilizer assembly having at least one anchor connected to a lower edge of the lower storage container; wherein the lower storage container is accessible without removal of the upper storage container from the stack assembly, and the at least one anchor is configured to be stepped on to provide a counterweight to an offset created by a displacement of the upper storage container when the lower storage container is accessed.

In aspects of the disclosure, broadly described herein, relate to a tool storage assembly further including the dolly assembly having a handle that is telescopically collapsible below a lower lid of the lower storage container.

In aspects of the disclosure, broadly described herein, relate to a tool storage assembly further including a tether connected to and between a lower compartment and the lower lid of the lower storage container, wherein the tether is configured to limit a distance the lower lid can be opened in relation to the lower compartment.

The tool storage assembly, broadly described herein, provides one or more of a multitude of advantages. These advantages may include: allowing work to be performed from one stationary upright tool storage assembly; limiting the need to occupy a broad work area caused by disassembly of the tool storage assembly and thereby reducing potential injury; limit the strain caused by lifting and setting down components of the tool storage assembly; reducing the need to bend over to access the tool storage assembly when disassembly does not occur; reducing the accumulation of dirt and debris to tool storage assembly from maintaining the height of the tool storage assembly and thereby increasing the lifespan of the tools contained therein; reducing disorganization caused by distance from tool storage assembly that occurs from disassembly; increased efficiency due to ready access to tools and supplies; increased clean up speed; reduced tool and component loss; simplified inventor; and other advantages.

This has outlined, rather broadly, the features, advantages, solutions, and benefits of the disclosure in order that the description that follows may be better understood. Additional features, advantages, solutions, and benefits of the disclosure will be described in the following. It should be appreciated by those skilled in the art that this disclosure may be readily utilized as a basis for modifying or designing other structures and related operations for carrying out the same purposes of the present disclosure. It should also be realized by those skilled in the art that such equivalent constructions and related operation do not depart from the teachings of the disclosure as set forth in the appended claims. The novel features, together with further objects and advantages, will be better understood from the following description when considered in connection with the accompanying Figures. It is to be expressly understood, however, that each of the Figures is provided for the purpose of illustration and description only and is not intended as a definition of the limits of the present disclosure.

### BRIEF DESCRIPTION OF THE DRAWINGS

FIG. 1 is a perspective view of a tool storage assembly according the prior art;

FIG. 2 is a perspective view of a tool storage assembly according the prior art;

FIG. 3 is a perspective view of a tool storage assembly according to an aspect of the disclosure;

FIG. 4 is a perspective view of a tool storage assembly according to an aspect of the disclosure;

FIG. 5 is a front view of a tool storage assembly according to an aspect of the disclosure;

FIG. 6 is a perspective view of a tool storage assembly according to an aspect of the disclosure;

FIG. 7 is a side view of a tool storage assembly according to an aspect of the disclosure;

FIG. 8 is a side view of a tool storage assembly according to an aspect of the disclosure;

FIG. 9 is a side view of a tool storage assembly according to an aspect of the disclosure;

FIG. 10 is a side view of a tool storage assembly according to an aspect of the disclosure;

FIG. 11 is a front view of a tool storage assembly according to an aspect of the disclosure;

FIG. 12 is a side view of a tool storage assembly according to an aspect of the disclosure;

FIG. 13 is a perspective view of a tool storage assembly according to an aspect of the disclosure;

FIG. 14 is a front view of a tool storage assembly according to an aspect of the disclosure;

FIG. 15 is a side view of a tool storage assembly according to an aspect of the disclosure;

FIG. 16 is a side view of a tool storage assembly according to an aspect of the disclosure;

FIG. 17 is a side view of a tool storage assembly according to an aspect of the disclosure;

FIG. 18 is a side, partial cross-section view of a tool storage assembly according to an aspect of the disclosure;

FIG. 19 is a front view of a tool storage assembly according to an aspect of the disclosure; and

FIG. 20 is a front view of a tool storage assembly according to an aspect of the disclosure.

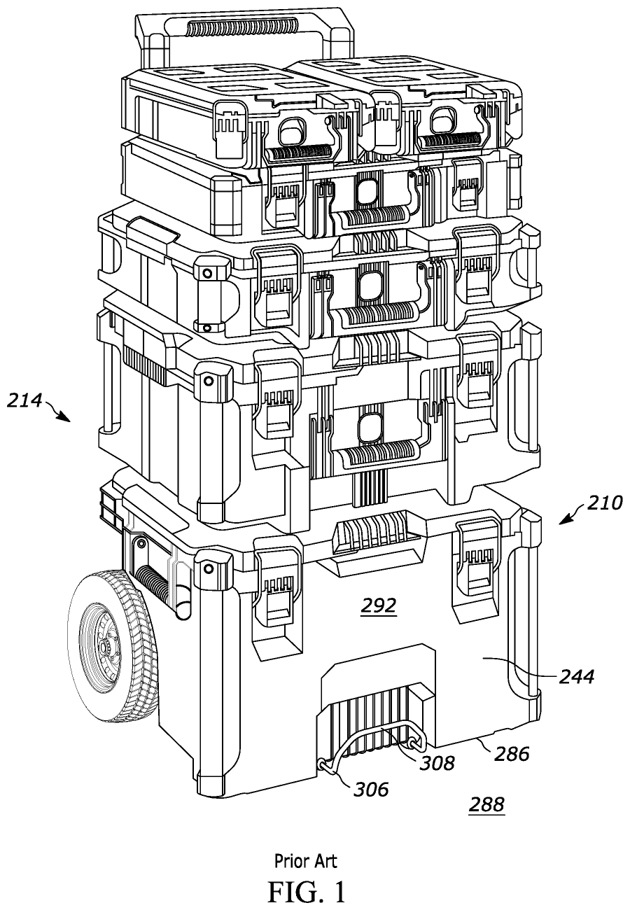

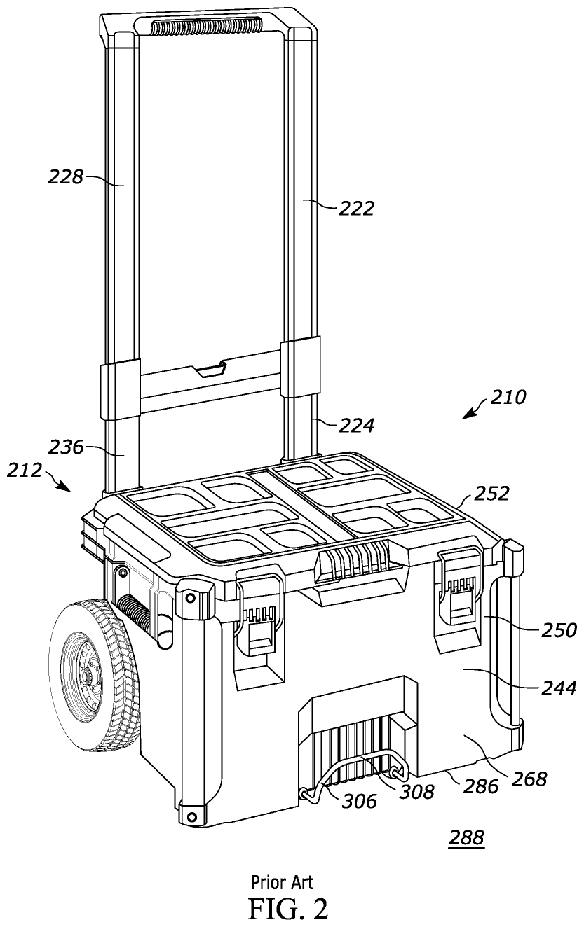

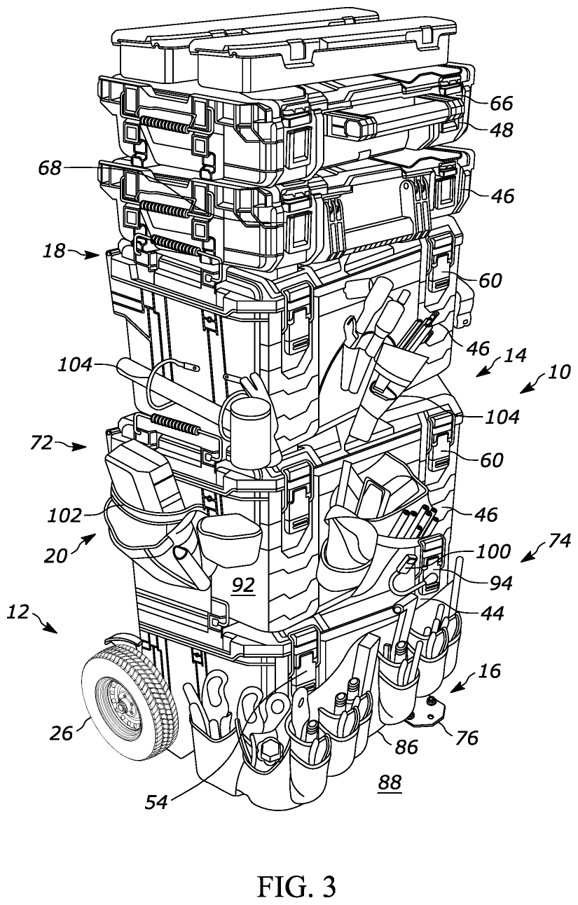

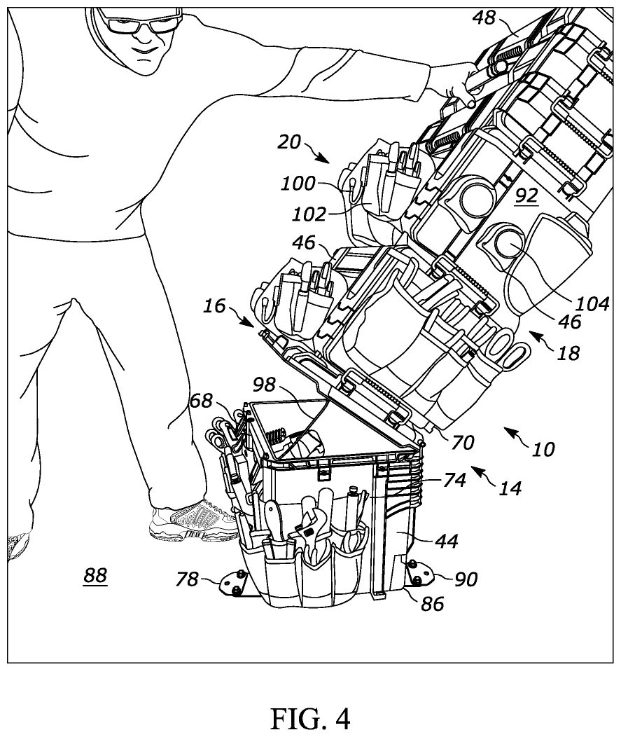

### DETAILED DESCRIPTION

The disclosure described herein is directed to different aspects of a tool storage assembly. The detailed description set forth below, in connection with the appended drawings, is intended as a description of various configurations and is not intended to represent the only configurations in which the concepts described herein may be practiced. These descriptions include specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

The disclosure is described herein with reference to certain aspects, iterations, embodiments, and examples but it is understood that the disclosure can be embodied in many different forms and should not be construed as limited to the aspects set forth herein.

Although the terms first, second, etc. may be used herein to describe various elements or components, these elements or components should not be limited by these terms. These terms are only used to distinguish one element or component from another. Hence, a first element discussed herein could be termed a second element without departing from the teachings of the present application. It is understood that actual systems or fixtures embodying the disclosure can be arranged in many different ways with many more features and elements beyond what is shown in the drawings. For the same or similar elements or features, the same reference numbers may be used throughout the disclosure.

It is to be understood that when an element or component is referred to as being “on” another element or component, it can be directly on the other element or intervening elements may also be present. Furthermore, relative terms such as “between”, “within”, “below”, and similar terms, may be used herein to describe a relationship of one element or component to another. It is understood that these terms are intended to encompass different orientations of the disclosure in addition to the orientation depicted in the figures.

Aspects of the disclosure may be described herein with reference to illustrations that are schematic illustrations. As such, the actual thickness of elements can be different, and variations from the shapes of the illustrations as a result, for example, of manufacturing techniques and/or tolerances are expected. Thus, the elements illustrated in the figures are schematic in nature and their shapes are not intended to illustrate the precise shape of a region of a device and are not intended to limit the scope of the disclosure.

With reference to the Figures aspects of a tool storage assembly 10 are shown according to the disclosure. The tool storage assembly 10 comprises one or more of a dolly assembly 12, a stack assembly 14, a stabilizer assembly 16, an interlock assembly 18, and an exterior storage system 20.

In some aspects, the dolly assembly 12 configured to transport the stack assembly 14 between locations as discussed herein. The dolly assembly 12 may comprise one or more of a handle 22, a handle receiver 24, and a pair of wheels 26. The handle 22 may have one or a pair of arms 28 and a grip 30 that extends between the pair of arms 28 at an upper terminal end 32 of the pair of arms 28. The grip 30 may connect atop of the upper terminal end of the one or the pair of arms 28. The pair of arms 28 may be of a telescopic construction such that the pair of arms 28 can be telescopically collapsed and extended. A lower terminal end 34 of the pair of arms 28 may be received in or connected to the handle receiver 24. In certain aspects, the pair of arms 28 are collapsible entirely or in-part within the handle receiver 24.

The handle receiver 24 may have a body 36, which may be rectangular and hollow such that at cavity 38 is formed within the body 36 to receive the pair of arms 28. The handle receiver 24 may have the pair of wheels 26 rotatably mounted to the body 36. The handle receiver 24, in some aspects, may have a platform 40, or base plate, that extends perpendicularly from a bottom 42 of the body 36, such that the stack assembly 14 can be set upon the platform 40.

In other aspects, the stack assembly 14 may comprise one or more of a lower storage container 44, an intermediate storage container 46, and/or an upper storage container 48. While the disclosure addresses the stack assembly 14 comprising three storage containers, the tool storage assembly 10 disclosed herein contemplates the stack assembly 14 comprising any number of storage containers, including those contemplated by the Figures.

The lower storage container 44 may comprise a lower compartment 50 that is connected to a lower lid 52. The lower compartment 50 may be hingedly connected to the lower lid 52 and may also have at least one of a lower latch 54 to secure the lower storage container 44 in a closed position with the lower lid 52 fully covering the lower compartment 50. The intermediate storage container 46 may comprise an intermediate compartment 56 that is connected to an intermediate lid 58. The intermediate compartment 56 may be hingedly connected to the intermediate lid 58 and may also have at least one of an intermediate latch 60 to secure the intermediate compartment 56 in a closed position with the intermediate lid 58 fully covering the intermediate compartment 56. The upper storage container 48 may comprise an upper compartment 62 that is connected to an upper lid 64. The upper compartment 62 may be hingedly connected to the upper lid 64 and may also have at least one of an upper latch 66 to secure the upper compartment 62 in a closed position with the upper lid 64 fully covering the upper compartment 62.

The handle 22 may collapse into the handle receiver 24 such that the handle 22, including the pair of arms 28 and/or the grip 30, is positioned below or flush with the lower lid 52 of the lower storage container 44. In this way, the handle 22 of the dolly assembly 12 does not and cannot interfere with the lower storage container 44 being opened beyond a right angle) (90°), even if there is the intermediate storage container 46 and/or the upper storage container 48 are stacked atop of the lower storage container 44.

The handle receiver 24 may be monolithically constructed with the stack assembly 14, such that the body 36 is of a uniform construction with the lower storage container 44 and may also be of uniform construction with the intermediate storage container 46 (including a plurality of the same) and/or the upper storage container 48. The lower storage container 44 is contemplated as referring to a storage container positioned lower than any other storage container in the stack assembly 14. In this way, the lower storage container 44, in some aspects is configured as the platform 40 of the dolly assembly 12 when the dolly assembly 12 and the stack assembly 14 are at least partially monolithically constructed as described and/or contemplated herein.

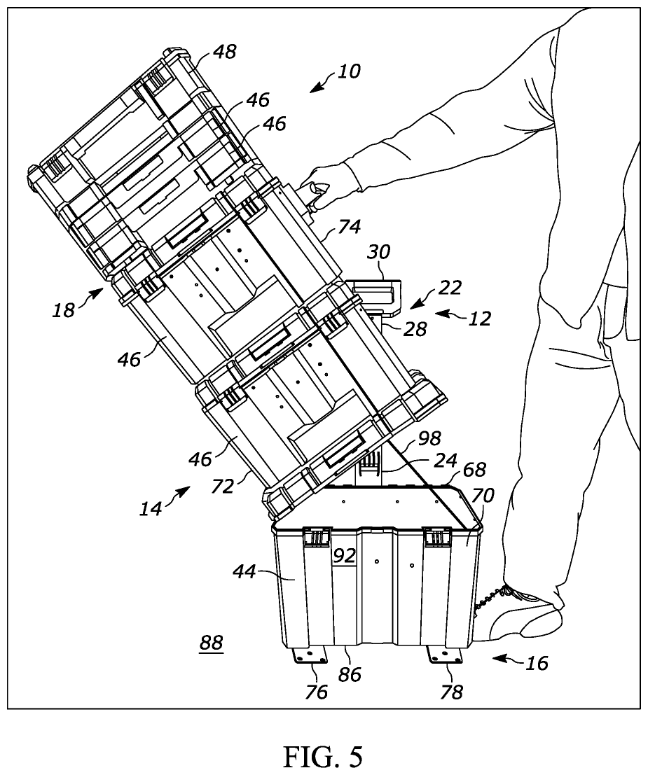

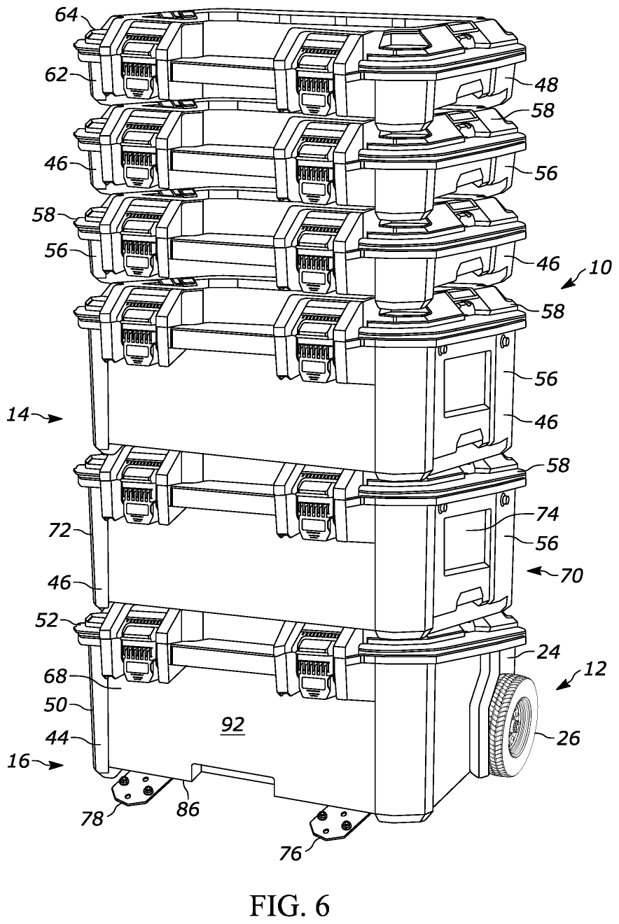

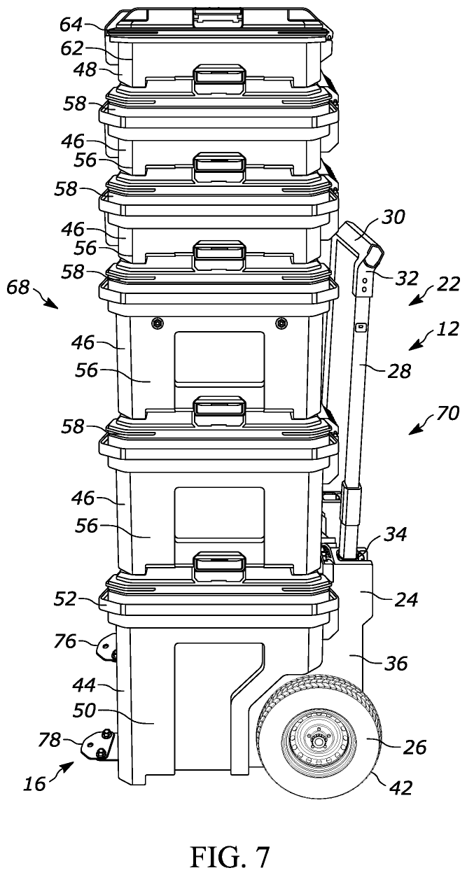

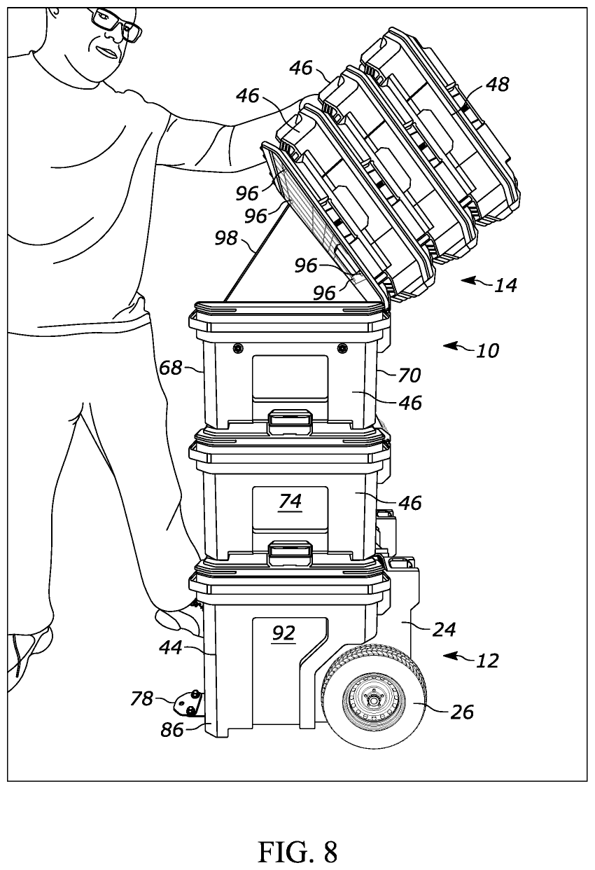

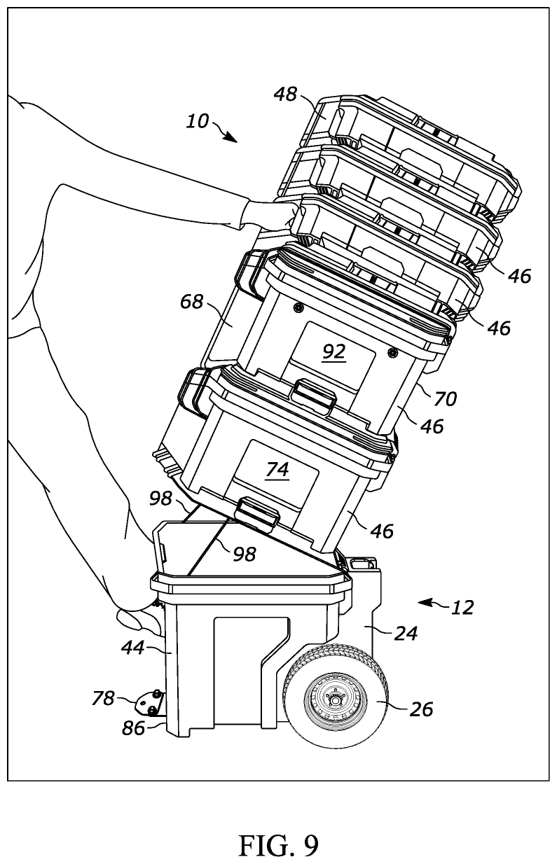

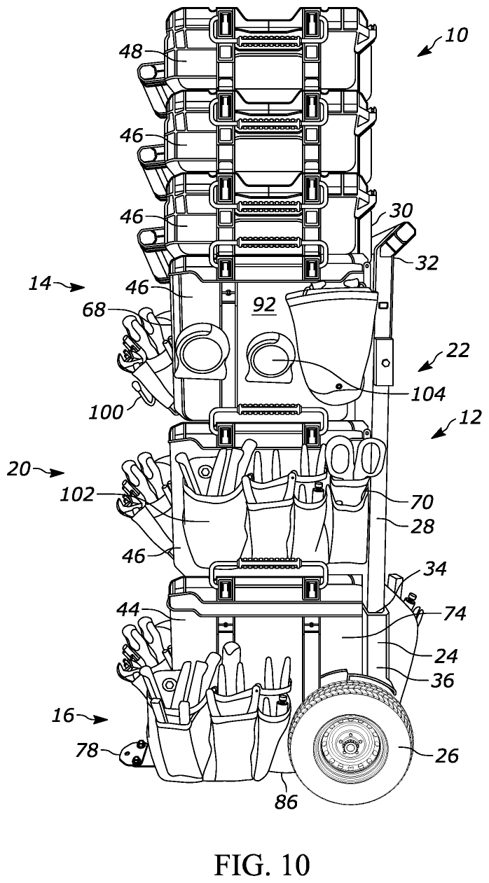

In other aspects, and with reference to the examples of FIGS. 5-10, the stack assembly 14 is oriented so that the lower storage container 44, the intermediate storage container 46, and/or the upper storage container 48 open from a front 68 of the tool storage assembly 10 in relation to the handle 22 that is positioned to a rear 70 of the tool storage assembly 10. In such a configuration, and with reference to FIG. 10, opening the lower storage container 44 may result in a “front-to-rear” position change for a remainder of the stack assembly 14 that tilt about an axis of the hinged connection between the lower compartment 50 and the lower lid 52 rearwardly, which in many instances results in at least a portion of the stack assembly 14 being positioned rearwardly beyond the dolly assembly 12. The offset in weight can, in some circumstances, can cause the tool storage assembly 10 to tip over and/or shift forward such that an individual opening the tool storage assembly 10 could be struck by the tool storage assembly 10. To counter the shift in weight caused by a front-to-rear position change, a stabilizer assembly 16 may be present.

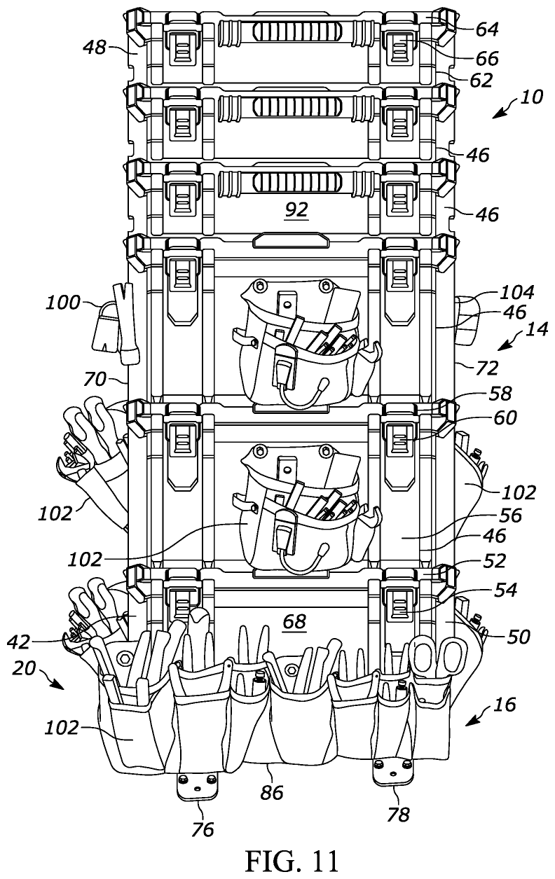

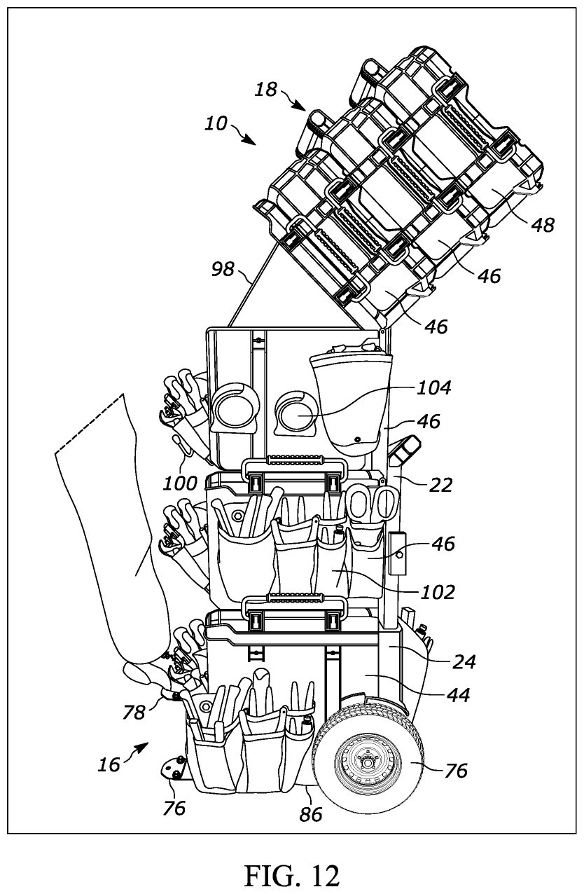

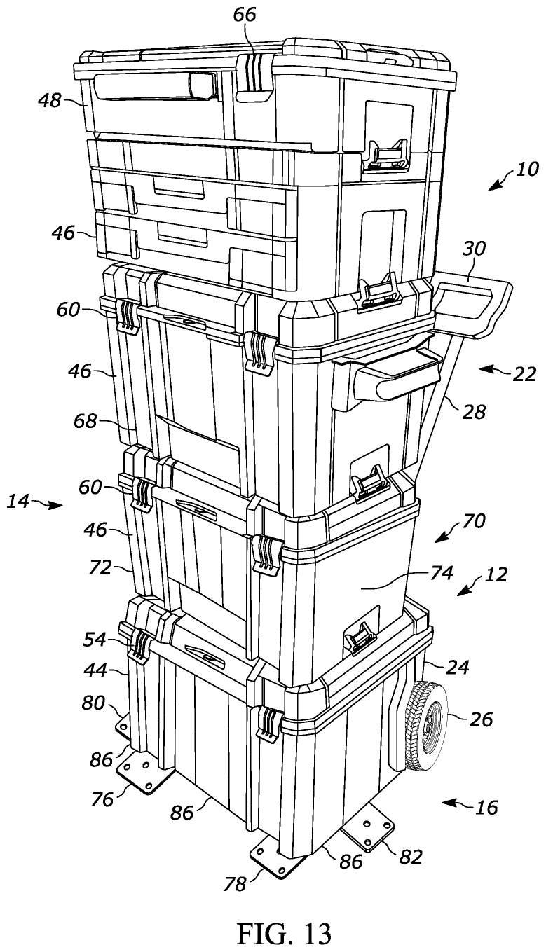

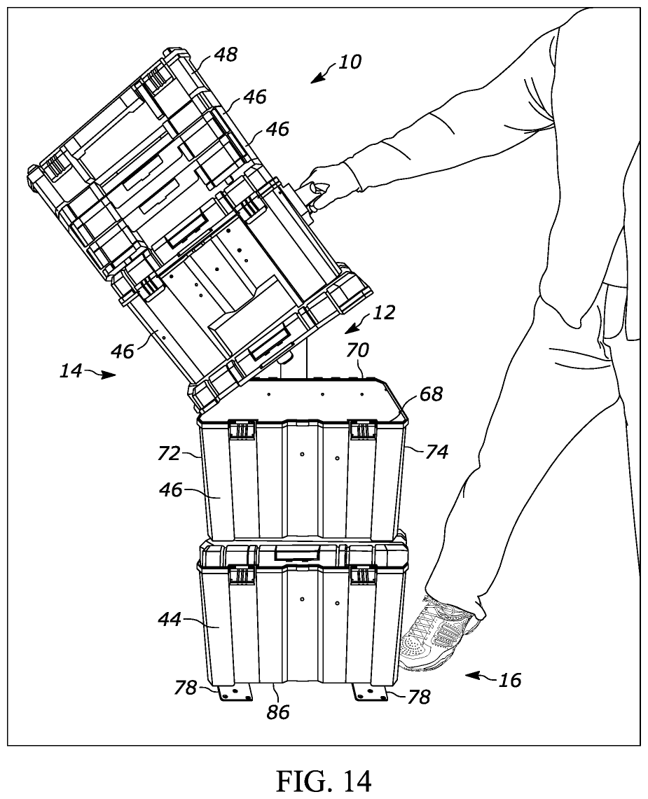

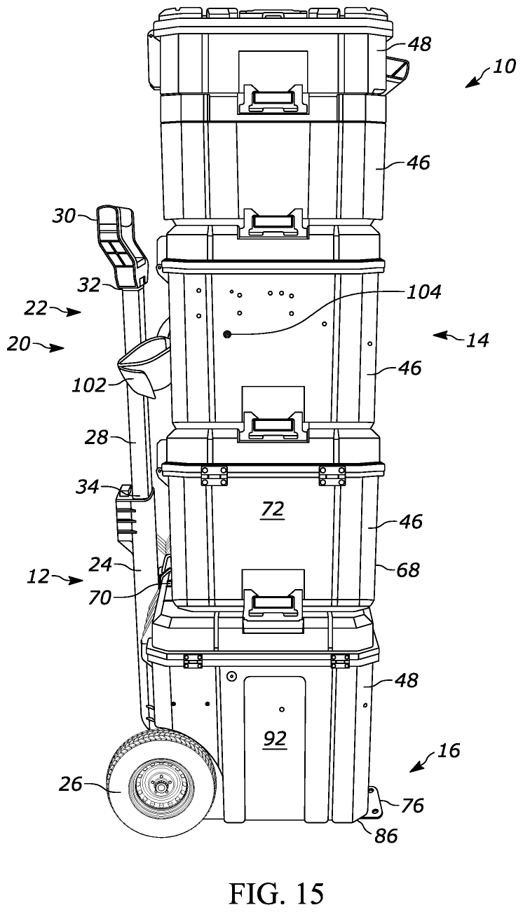

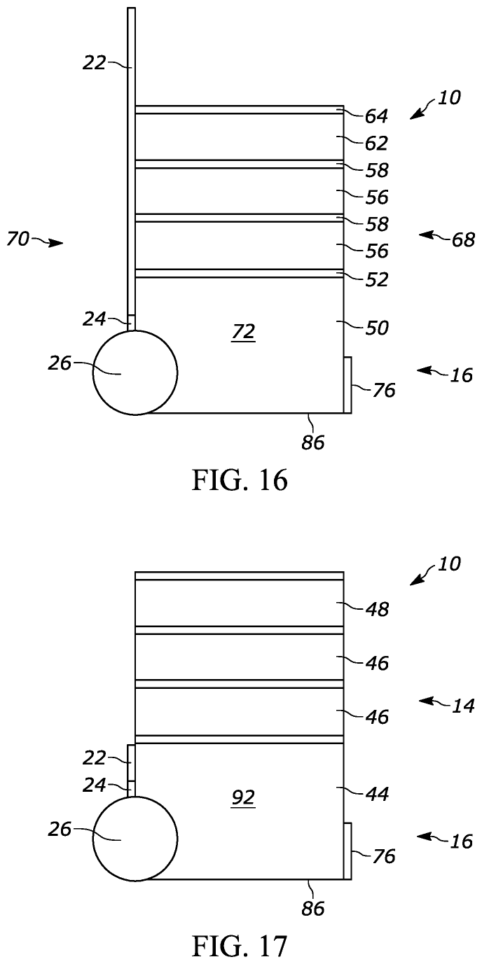

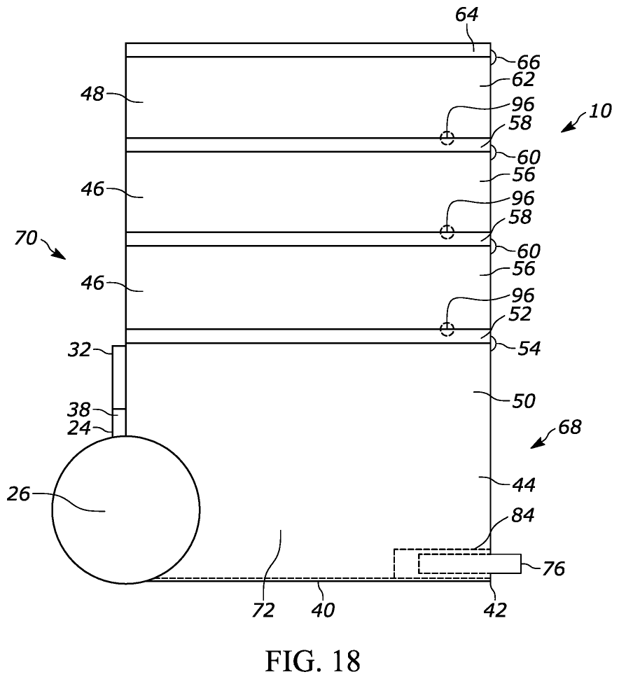

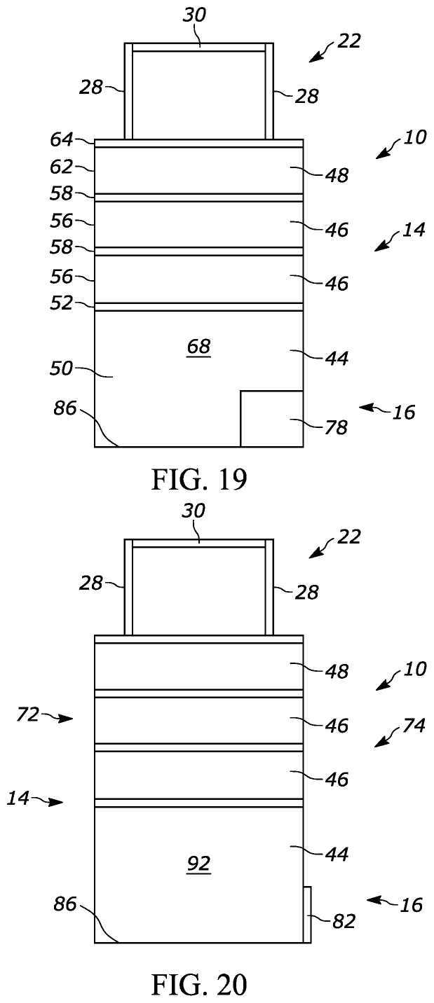

In an alternative configuration, as seen in the examples of FIGS. 11 and 12, the stack assembly 14 is oriented so that the lower storage container 44, the intermediate storage container 46, and/or the upper storage container 48 open from a first side 72 of the tool storage assembly 10 in relation to the handle 22 that is positioned to a rear 70 of the tool storage assembly 10. In such a configuration, and with reference to FIG. 12, opening the lower storage container 44 results in a “side-to-side” position change for a remainder of the stack assembly 14 that tilt about an axis of the hinged connection between the lower compartment 50 and the lower lid 52 on a second side 74 of the tool storage assembly 10, which in many instances results in at least a portion of the stack assembly 14 being positioned entirely beyond the second side of the tool storage assembly 10 as compared to when the stack assembly 14 is not opened. The offset in weight in some circumstances can cause the tool storage assembly 10 to tip over. To prevent or limit the potential of tipping during the side-to-side position change, a stabilizer assembly 16 may be present. Moreover, in the side-to-side orientation, the tool storage assembly 10 has the advantage of not requiring a handle 22 that can be removed or lowered to allow opening on any portion of the stack assembly 14 as neither the handle 22 nor the handle receiver 24 are obstructing movement. Additionally, the side-to-side orientation reduces if not eliminates the risk of the tool storage assembly 10 from shifting towards the individual opening the tool storage assembly 10 as the wheels 26 are arranged axially to move forwardly or rearwardly, but not to the sides.

In still other aspects, the stabilizer assembly 16 is configured to limit or prevent tipping or slippage when the stack assembly 14 is opened as discussed herein by providing a counterweight or obstacle. The stabilizer assembly 16 may comprise one or more anchors 76, which may include a front anchor 78, a side anchor 80, and a second side anchor 82 (not shown), and/or may further comprise an anchor recess 84. The one or more anchors 76 may be in the form of a foot plate that can be stepped on by an individual during use to provide a counterweight when the stack assembly 14 is opened and/or or slid under a structure such as a wall or door to inhibit or prevent the tool storage assembly 10 from tilting beyond a limitation area.

The front anchor 78 may extend from a lower edge 86 of the lower storage container 44 from the front 68 of the tool storage assembly 10, such that the front anchor 78 extends substantially flush or flush with a ground surface 88 in a direction away from the front 68 of the tool storage assembly 10. In some such aspects, the front anchor 78 may be offset along the length of the lower edge 86 such that the front anchor 78 is positioned closer either the first side 72 or the second side 74 of the tool storage assembly 10, which positions the front anchor 78 in a more natural position to be stepped on when the tool storage assembly 10 is approached from the front 68 during use and particularly when used with the stack assembly 14 that has the front-to-rear configuration.

Additionally, or alternatively, the side anchor 80 may extend from the lower edge 86 of the lower storage container 44 from the first side 72 of the tool storage assembly 10, such that the side anchor 80 extends substantially flush or flush with the ground surface 88 in a direction away from the first side 72 of the tool storage assembly 10. In certain aspects, the side anchor 80 may be offset such that the side anchor 80 is positioned close to either the front 68 or the rear 70 of the tool storage assembly 10 in order to provide the advantage of ergonomic use as described herein. In configurations of the tool storage assembly 10 having both the front anchor 78 and the side anchor 80 (as well as in aspects also comprising the second side anchor 82), the side anchor 80 can be positioned under a structure while further limiting the potential of tipping or slipping out when the tool storage assembly 10 is in a front-to-rear configuration. Conversely, the front anchor 78 can be positioned under a structure to provide similar advantages when the tool storage assembly is in a side-to-side configuration. The presence of both the front anchor 78 and the side anchor 80 also allows for the stack assembly 14 to be comprised of a mix of opening configurations—for example, the lower storage container 44 having a side-to-side configuration making use of the side anchor 80 more practical for an individual to step on and the upper storage container 48 having a front-to-rear configuration making use of the front anchor 78 more practical for an individual to step on. The presence of a rear anchor 90 providing similar advantages over the prior art is also considered.

The one or more anchors 76 may be connected to the lower storage container 44 in a fixed manner to provide strength and rigidity during use. Such a connection may be accomplished by the one or more anchors 76 being monolithically construction with the lower storage container 76. The one or more anchors 76 may be hingedly connected to the lower storage container 44 to allow the one or more anchors 76 to be transitioned from extending perpendicularly away from an exterior of the stack assembly 14 to a position extending substantially flush or flush with the exterior 92 of the stack assembly 14 thereby reducing the overall dimensions of the tool storage assembly 10 and reducing the chance for the one or more anchors 76 to be struck by the individual inadvertently causing harm. The one or more anchors 76 may be removable, i.e., not fixed, such that an individual can install and/or remove the one or more anchors 76 without tools, such as by way of example, friction fit or snap fit, thereby achieving similar advantages to a hinged connection, though more time consuming and cumbersome to use. The one or more anchors 76 may be slidably or recessively connected to the lower storage container 44, such that the one or more anchors 76 are insertable into the anchor recess 84 formed in the lower compartment 50 such that the one or more anchors 76 only partially extends or does not extend beyond the front 68 of the stack assembly 14, which provides similar advantages to a hinged connection but requires a reduction in the lower compartment 50 size and makes retrofitting the stack assembly 14 that is preexisting less likely. Other connective configurations are contemplated herein, including spring-loaded (e.g., pop-out), sway, pivotable, rotatable, detachable, actuatable, and the like. While some of the configurations discussed have disadvantages, advantages remain over the prior art.

The one or more anchors 76 may be texturized to provide additional grip when stepped upon. The one or more anchors 76 may include boot rails 77 (not shown) that are configured to prevent a foot from sliding off the sides of the one or more anchors 76.

The one or more anchors 76 may also be connected to the intermediate storage container 46 and/or the upper storage container 48, including by connection configurations discussed herein. In such configurations, the one or more anchors 76 can be used to access any part of the stack assembly 14 that is disassembled from the lower storage container 44. For example, should an individual remove the intermediate storage container 46 and the upper storage container 48 but keep them stacked to one another, the one or more anchors 76 can be used on the intermediate storage container 46 to prevent or limit the potential of the upper storage container 48 causing a tip or slip out during either a front-to-rear or side-to-side change caused by opening the lower storage container 44.

In yet other aspects, the interlock assembly 18 is configured to secure the stack assembly 14 together, which allows the stack assembly 14 to have a rigid or semi-rigid structure, such that accessing the lower storage container 44 or intermediate storage container 46 does not require disassembly of the stack assembly 14 due to interconnections between the lower storage container 44, the intermediate storage container 46, and/or the upper storage container 48. The interlock assembly 18 may comprise the stack assembly 14 on or more of one or more container latch 94, one or more lid fastener 96, and/or of one or more lid one or more tether 98.

The one or more container latch 94 are configured to provide a dynamic and selective interconnection amongst the stack assembly 14. The one or more container latch 94 may extend between and connect one or more of the lower storage container 44, the intermediate storage container 46, and the upper storage container 48 to one another. The one or more container latch 94 may fixedly connect to the lower compartment 50 and releasably connect to the intermediate compartment 56 or vice versa. The one or more container latch 94 may fixedly connect to the intermediate compartment 56 and releasably connect to the upper compartment 62 or another of the one or more container latch 94. In this way, the interconnection amongst the stack assembly 14 is selective based on which of the one or more container latch 94 are in use.

The one or more lid fastener 96 are configured to provide a static and fixed interconnection amongst the stack assembly 14. The one or more lid fastener 96 may be positioned below and extend through the lower lid 52 and extend through and above the intermediate compartment 56 such that the lower lid 52 and intermediate compartment 56 are held together. Similarly, the one or more lid fastener 96 may be positioned below and extend through the intermediate lid 58 and extend through and above the upper compartment 62 such that the intermediate lid 58 and the upper compartment 62 are held together. The one or more lid fastener 96 may include one or more nut and bolt, fastener, pin, post, or the like. As an alternative to the one or more lid fastener 96, the intermediate compartment 56 and the upper compartment 62 may be formed too close to the lower compartment 50 and the intermediate compartment 56, such that the lower lid 52 and the intermediate lid 58 is not present in the stack assembly 14. In this way, at least a portion of the stack assembly 14 is structured as a single body having hinged components.

With reference to FIGS. 10 and 12, the one or more tether 98 is configured to limit the distance by which the lower storage container 44, the intermediate storage container 46, and/or the upper storage container 48 can be opened during use. The one or more tether 98 may extend between the lower lid 52 and the lower compartment 50 such that when the lower lid 52 is opened the one or more tether 98 becomes taught one the lower lid 52 is opened a predefined distance—for example, 90°. In this way, the lower compartment 50 can be accessed with both hands by an individual as the intermediate storage container 46 when at least the intermediate storage container 46 is interlocked with the lower storage container 44. While tipping or tilting would usually be of concern, the use of the stabilizer assembly 16 counteracts the weight displacement created by the position of the intermediate storage container 46. The one or more tether 98 may extend between the intermediate compartment 56 and the intermediate lid 58 to provide a similar advantage. The one or more tether 98 may extend between the upper compartment 62 and the upper lid 64 to maintain the upper lid 64 in a position that is easily reachable to close the upper lid 64 when desired.

In other aspects, the exterior storage system 20 is configured to store tools and/or materials about the exterior 92 of the stack assembly 14 to provide ready access. The exterior storage system 20 may comprise one or more of a hook 100, one or more of a pouch 102, and/or one or more of a clip 104. The exterior storage system 20 may be connected anywhere about the exterior 92 of the stack assembly 14.

In an exemplary operation having two of the intermediate storage container 46 in addition to the bottom 42 and the lower storage container 44, the tool storage assembly 10 has the stack assembly 14 fully assembled and the handle 22 of the dolly assembly 12 extended. Using the grip 30, the tool storage assembly 10 is tilted backwards about an axis extending through the wheels 26, which facilitates movement to a desired location. The interlock assembly 18 provides additional rigidity to the stack assembly 14 to limit or avoid any of the stack assembly 14 becoming dislodged during transport.

Once the desired location is reached, the tool storage assembly 10 is positioned upright using the dolly assembly 12. The handle 22 is lowered into the handle receiver 24 to allow unfettered access to the stack assembly 14. The front anchor 78 is extended, such as by way of hinged movement, to extend outwardly away from the lower storage container 44. Then the front anchor 78 is stepped on by an individual while the lower of the two of the intermediate storage container 46 is opened, thereby moving the upper of the two of the intermediate storage container 46 and the upper storage container 48 due to the interlock assembly 18, which offsets the weight. The individual's step on the front anchor 78, however, counteracts this offset so that the tool storage assembly 10 does not topple. To access the intermediate compartment 56 with both hands, the one or more tether 98 is allowed to fully extend and limit further movement of the lower lid 52 upon which a portion of the stack assembly 14 is interlocked.

If desirable, the one or more container latch 94 between the two of the intermediate storage container 46 is detached to allow the upper of the two of the intermediate storage container 46 and the upper storage container 48 to be removed as one from the stack assembly 14 and set aside. Then, the lower storage container 44 is opened with the remainder of the stack assembly 14 still present. Additionally, access to one or more tools or materials is provided by the exterior storage system 20. Upon completion, the stack assembly 14 is reassembled, if needed. Then the handle 22 is extended to again allow transport of the tool storage assembly 10.

The preceding operation is exemplary only and is not intended to limit the scope or spirit of the invention in any way. Additional exemplary operations of the tool storage assembly 10 are set forth herein as well as other operations that would be readily understood by those skilled in the art.

Therefore, a tool storage assembly 10 has been provided that improves access to a plurality of storage containers arranged in a stack, limits or obviates disassembly of the stack to retrieve materials contained in a lower storage container, can be retrofitted to a dolly assembly and stack assembly that are pre-existing, provides a counterweight to offset stack displacement during use, improves the rigidity of the stack during transport and use, reduces tipping, toppling, and/or slipping out, is modular and transportable, improves safety, is user-friendly, and/or otherwise improves upon the art.

From the above discussion and accompanying figures and claims it will be appreciated that the tool storage assembly 10 offers many advantages over the prior art. Although the present disclosure and its advantages have been described in detail, it should be understood that various changes, substitutions, modifications, and alterations can be made herein without departing from the technology of the disclosure as defined by the appended claims. The scope of the present application is not intended to be limited to the particular configurations of the process, machine, manufacture, composition of matter, means, methods and steps described in the specification only expressly stated otherwise. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A tool storage assembly comprising:
a dolly assembly connected to a stack assembly;
the stack assembly having an upper storage container stacked atop a lower storage container; and
a stabilizer assembly having at least one anchor connected to a lower edge, wherein the at least one anchor extends perpendicularly away from the stack assembly;
wherein the lower storage container is accessible without removal of the upper storage container from the stack assembly, and the at least one anchor is configured to be stepped on to provide a counterweight to an offset created by a displacement of the upper storage container when the lower storage container is accessed.

2. The tool storage assembly of claim 1 wherein the at least one anchor is hingedly connected to the lower storage container.

3. The tool storage assembly of claim 1 further comprising the counterweight received on the at least one anchor, wherein the counterweight offsets the displacement of the upper storage container when the lower storage container is open with the upper storage container positioned atop of the lower storage container.

4. The tool storage assembly of claim 1 further comprising an interlock assembly is configured to secure the stack assembly together.

5. The tool storage assembly of claim 1 further comprising an exterior storage system configured to store materials to an exterior of the stack assembly.

6. The tool storage assembly of claim 1 further comprising the lower storage container having a lower compartment and a lower lid, wherein the lower lid is configured to open from a first side of the stack assembly towards a second side of the stack assembly; and the dolly assembly having a handle connected to a rear of the stack assembly.

7. The tool storage assembly of claim 6 wherein the at least one anchor includes a side anchor connected to the lower edge on the first side of the stack assembly.

8. The tool storage assembly of claim 7 wherein the at least one anchor includes a front anchor connected to the lower edge of the first side of the stack assembly.

9. The tool storage assembly of claim 1 further comprising the lower storage container having a lower compartment and a lower lid, wherein the lower lid is configured to open from a front of the stack assembly towards a rear of the stack assembly; and the dolly assembly having a handle connected to the rear of the stack assembly.

10. The tool storage assembly of claim 9 wherein the at least one anchor includes a front anchor connected to the lower edge of a front side of the stack assembly.

11. The tool storage assembly of claim 1 further comprising the dolly assembly having a handle that is telescopically received within a handle receiver, wherein when telescopically collapsed the handle is positioned at least flush with a lower lid of the lower storage container such that the handle does not obstruct the lower lid from opening more than a right angle in relation to a lower compartment of the lower storage container.

12. The tool storage assembly of claim 11 wherein the handle receiver is monolithically constructed with at least the lower storage container.

13. The tool storage assembly of claim 1 further comprising a tether connected to and between a lower compartment and a lower lid, wherein the tether is configured to limit a distance the lower lid can be opened in relation to the lower compartment.

14. The tool storage assembly of claim 1 further comprising a lid fastener positioned below and through a lower lid of the lower storage container and through and above an intermediate compartment of an intermediate storage container, wherein the lid fastener is configured to provide a static and fixed interconnection between the lower storage container and the intermediate storage container of the stack assembly.

15. The tool storage assembly of claim 1 further comprising the stack assembly having an intermediate storage container; the intermediate storage container having a front anchor extending away from a front of the stack assembly.

16. The tool storage assembly of claim 1 wherein the at least one anchor is slidably connected to the lower storage container, wherein the at least one anchor is selectively receivable within an anchor recess formed in the lower storage container.

17. A tool storage assembly comprising:
a dolly assembly connected to a stack assembly;
the stack assembly having an upper storage container stacked atop a lower storage container;
the upper storage container selectively stacked atop the lower storage container by an interlock assembly; and
a stabilizer assembly having at least one anchor connected to a lower edge of the lower storage container;
wherein the lower storage container is accessible without removal of the upper storage container from the stack assembly, and the at least one anchor is configured to be stepped on to provide a counterweight to an offset created by a displacement of the upper storage container when the lower storage container is accessed.

18. The tool storage assembly of claim 17 further comprising the dolly assembly having a handle that is telescopically collapsible below a lower lid of the lower storage container.

19. The tool storage assembly of claim 18 further comprising a tether connected to and between a lower compartment and the lower lid of the lower storage container, wherein the tether is configured to limit a distance the lower lid can be opened in relation to the lower compartment.
